(19) United States
(12) Patent Application Publication
(10) Pub. No.: US 2021/0063608 A1
(43) Pub. Date: Mar. 4, 2021

(54) UNIBODY OPTICAL GRADE PLASTIC MONITOR FOR IN-FLIGHT ENTERTAINMENT SYSTEM

(71) Applicant: Panasonic Avionics Corporation, Lake Forest, CA (US)

(72) Inventors: Shrenik Shah, San Juan Capistrano, CA (US); Feng Jiang, Irvine, CA (US); Gary Chen, Rancho Santa Margarita, CA (US); Cedric Rhoads, Trabuco Canyon, CA (US)

(21) Appl. No.: 17/011,762

(22) Filed: Sep. 3, 2020

Related U.S. Application Data
(60) Provisional application No. 62/895,909, filed on Sep. 4, 2019.

(51) Int. Cl. G02B 1/111; G02B 1/118

(52) U.S. Cl. CPC G02B 1/111; G06F 3/041; G02B 1/118

(57) ABSTRACT

A unibody optical grade plastic monitor for a seatback device for a vehicle entertainment system for a commercial passenger vehicle. The monitor has a light weight layer cross-sectional structure that includes a front optical grade plastic cover and a rear plastic cover, a touch panel, a display panel, and one or more layers of anti-reflection plastic films (e.g., Mosmite(s)) between the touch panel and the display panel.

### PRIORITY CLAIM

This patent document claims the benefit of priority of U.S. Provisional Patent Application 62/895,909 entitled “Unibody Optical Grade Plastic Monitor for In-Flight Entertainment System,” filed on Sep. 4, 2019. The aforementioned application is incorporated in its entirety in the present document.

### TECHNICAL FIELD

This document is directed generally to obtain and use a unibody optical grade plastic monitor for commercial passenger vehicles.

### BACKGROUND

Commercial travel has evolved to provide entertainment options to passengers traveling to their destinations. For example, in an airplane or train, entertainment options are provided on monitors located on the back of seats, where the monitors can enable passengers to watch movies or television shows as they travel to their destinations. The monitors need to be of such a construction to provide head-injury protection to passengers should they strike their head on the monitor due to sudden deceleration of the vehicle or other event. In particular, the monitors must meet requirements pertaining to Head Injury Criterion (HIC) (see for example Section 25.562 of Title 14 of the Code of Federal Regulations). In many conventional monitor systems, most of the monitors used in in-flight entertainment (IFE) systems have a cover glass at the front. Even though that glass is normally covered by a sheet of PET film, it can still easily shatter upon impact, i.e., based on test results from HIC testing. Consequently, glass shards can potentially escape from a PET film cover and be exposed to passengers. This creation/escape of glass shards during a monitor (HIC) test would be considered a failure.

### SUMMARY

This patent document describes an exemplary unibody optical grade plastic monitor for a vehicle entertainment system for a commercial passenger vehicle. The monitor includes front optical grade plastic, e.g., polycarbonate, cover and a rear plastic, e.g., polycarbonate, cover, touch panel, display panel, and one or more layers of anti-reflection plastic films (e.g., Mosmite(s)) between touch panel and display panel. The term “exemplary” as used herein means as an illustrative, non-limiting example or instance and not necessarily the best, preferred and/or optimal embodiment.

In an exemplary embodiment, a front optical grade polycarbonate cover forms a front cover of a touch panel. The front optical grade polycarbonate cover has an outer perimeter that surrounds an outer perimeter of the touch panel and a display panel. Dual-layers of anti-reflection plastic film separates the touch panel and the display panel. A rear polycarbonate cover forms a back cover of the display panel. The rear polycarbonate cover has an outer perimeter that surrounds an outer perimeter of the touch panel and the display panel. The front optical grade polycarbonate cover and rear polycarbonate cover are connectively coupled using a welding process.

In an exemplary embodiment, the welding process comprises laser or chemical welding. As such, the welding process fuses the front optical grade polycarbonate cover and the rear polycarbonate cover together to seamlessly form a unibody (e.g., singular) polycarbonate monitor housing. Advantageously, a singular polycarbonate housing can withstand extreme impact without shattering or releasing any glass shards from inside, i.e. from a cracked/shattered touch panel and/or display panel.

In an exemplary embodiment, the touch panel is optically bonded to inner surface of front optical grade polycarbonate cover. In an exemplary embodiment, dual layers of anti-reflection plastic film includes a layer of moth-eye anti-reflection plastic film (e.g., Mosmite) is laminated on an inside surface of the touch panel. In an exemplary embodiment, a layer of anti-reflection plastic film (e.g., Mosmite) is laminated on front side of the display panel.

Advantageously, the combination of the two layers of Mosmite will effectively remove glare and improve image quality of the display panel. At the same time, the two layers of Mosmite provides a firm support for the front optical grade polycarbonate cover/touch panel assembly. For example, when passengers press on a monitor (to access a movie, an Internet site, a mapping function or the like), there will be little if any noticeable sagging or deflection of the front optical grade polycarbonate cover.

Advantageously, because the display panel is not permanently bonded to the touch panel/front optical grade polycarbonate cover assembly, the display panel can be easily removed from (separated from) the unibody polycarbonate monitor if needed. For example, the monitor may be found defective, need rework, need retrofitting, upgrading or other reason requiring removal of the monitor.

The above and other aspects and their implementations are described in greater detail in the drawings, the descriptions, and the claims.

### BRIEF DESCRIPTION OF THE DRAWINGS

FIGS. 1 and 2 show respectively an exploded front left perspective view and rear left perspective view of the components of a first exemplary monitor for a vehicle entertainment system installed in a commercial passenger vehicle.

FIG. 3 shows a side cross-section view of the first exemplary monitor for the vehicle entertainment system in a commercial passenger vehicle of FIGS. 1 and 2.

FIGS. 4 and 5 show respectively an exploded front left perspective view and rear left perspective view of the components of a second exemplary monitor for a vehicle entertainment system installed in a commercial passenger vehicle.

FIG. 6 shows a side cross-section view of the second exemplary monitor for the vehicle entertainment system in a commercial passenger vehicle of FIGS. 4 and 5.

FIG. 7 shows an exemplary flowchart of a method of assembling/manufacturing the exemplary monitor for the vehicle entertainment system in a commercial passenger vehicle.

### DETAILED DESCRIPTION

Currently, airplanes or other commercial vehicles use conventional in-vehicle entertainment systems to broadcast audio or video content to seatback devices located on the rear of the seat or to personal electronic devices (PEDs) (e.g., smartphone, laptops, or tablets) that belong to passengers. Display devices of the in-vehicle entertainment system may also be mounted to walls, bulk heads, seat arms and other areas. For convenience of explanation, the term seatback device is defined here as including these display devices. The audio or video content may include movies, television shows, or other content such as advertisements or flight safety videos. Each seatback device has an enclosure that can have a processor executing custom software programs to receive messages or commands from an edge server and to display visual content on a display of the seatback device and to output sound to a headphone jack. Conventional in-vehicle entertainment systems can also wirelessly transmit audio or video content to PEDs that belong to passengers.

In many conventional systems, within an entertainment monitor for a commercial passenger vehicle, e.g., train, boat, bus, airplane, or the like, a display panel is either optically bonded to a touch panel/cover glass or are set apart to a touch panel/cover glass so there is an air gap between them. The optical bonding removes glare and provides a much superior image quality. However, it's a relatively expensive process. Furthermore, it is difficult, if not impossible, for a finished monitor assembly to be separated again if, for instance, rework or retrofitting or upgrading of, for instance, the touch panel, cover glass, or the display panel is desired/required. On the other hand, if the display panel and cover touch panel (CTP)/cover glass are set apart with an air gap between them, there can be visible glare and/or double reflections. As such, this glare and/or double reflections is/are not desired when image quality on the display panel is important, e.g., watching movies, playing video games, surfing the Internet, or the like. As such, a monitor topology for an in-vehicle entertainment systems that provides improvements over conventional monitors will be advantageous. For example: lowered production costs, easier rework/upgrade capability, better HIC testing results, and improved display panel image quality that will provide passengers with a better travel and IFE experience.

This document describes techniques that may be embodied as a unibody polycarbonate monitor for a seatback device for a vehicle entertainment system for a commercial passenger vehicle. In some embodiments, the optical grade polycarbonate material for the front cover may be replaced by other like optical grade plastics, e.g., Acrylic, Polystyrene, Polycarbonate (as in the exemplary embodiment), Cyclic Olefin Polymer (COP), Cyclic Olefin Copolymer, Nas, or the like. In some embodiments, the polycarbonate material for the rear cover may be replaced by other like grade plastics (that does not necessarily have to be optical grade or quality) including any or all the following plastics: Acrylic, Polystyrene, Polycarbonate, Cyclic Olefin Polymer (COP), Cyclic Olefin Copolymer, Nas, or the like.

One advantageous aspect of a monitor according to some techniques will have a light weight structure that includes a front optical grade plastic cover and a rear plastic cover, a touch panel, a display panel, and one or more layers of anti-reflection plastic films (e.g., Mosmite(s)) between the touch panel and the display panel. In particular, Mosmite is a trademark of Mitsubishi Chemical Corporation under which it manufactures and markets a biomimetic material having a nanostructure exhibiting antireflective properties. More particularly, the material emulates the fine structure of moth eyes. The material is available as a film from Mitsubishi Chemical Corporation of Tokyo, Japan. In some embodiments, other types of anti-reflective films may be used, such as an index matching film or a single-layer interference film or a multi-layer interference film or an absorbing film or a circular polarizing film, and so on.

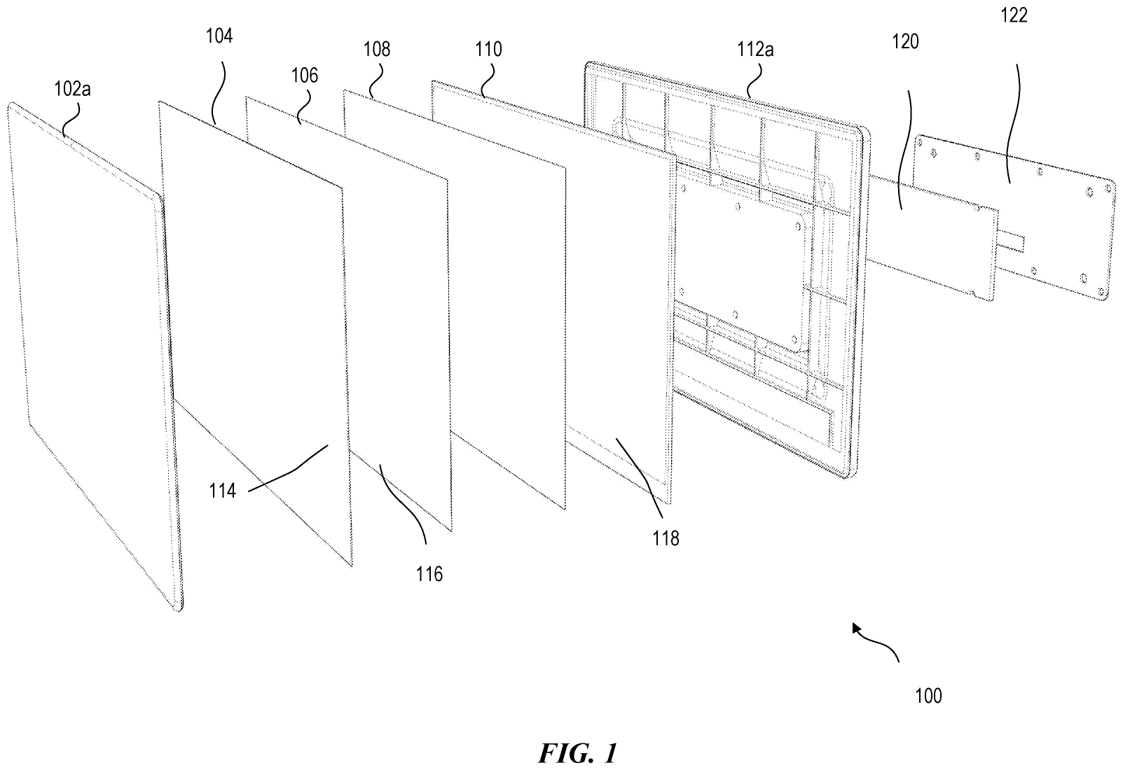

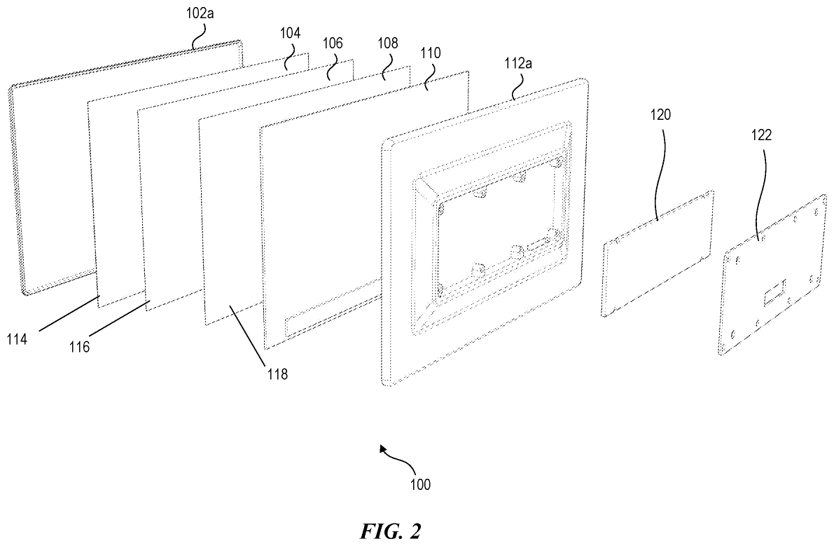

FIGS. 1 and 2 illustrate respectively an exploded front left perspective view and a rear left perspective view of the components of an exemplary unibody polycarbonate monitor for a vehicle entertainment system installed in a commercial passenger vehicle.

Referring to FIG. 1, the exploded front left perspective view of the monitor 100, from left to right, includes a front optical grade polycarbonate cover 102a, touch panel 104, anti-reflective plastic film 106, anti-reflective film 108, display panel 110, rear polycarbonate cover 112a, printed circuit board (PCB) 120, and printed circuit board (PCB) cover 122.

Referring to FIG. 2, the exploded rear perspective view of the monitor 100 from right to left, includes a front optical grade polycarbonate cover 102a, touch panel 104, anti-reflective plastic film 106, anti-reflective film 108, display panel 110, rear polycarbonate cover 112a, printed circuit board (PCB) 120, printed circuit board (PCB) cover 122.

In one exemplary embodiment, the front optical grade polycarbonate and rear polycarbonate covers 102a, 112a are affixed to each other by one or more affixation processes. For example, in some embodiments, a process such as a welding process may be used joined together where they make contact around an outer perimeter of monitor 100.

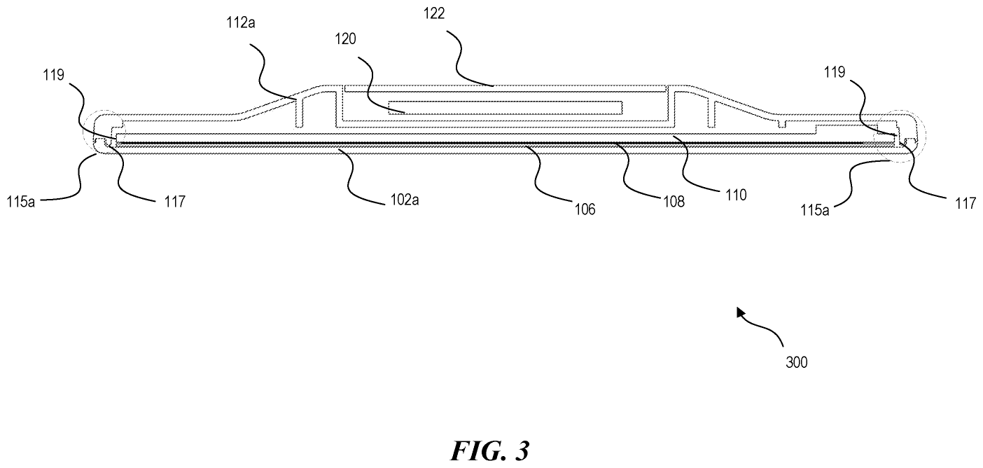

More specifically as referenced in FIG. 3, the welding process in area 115a fuses along an outer perimeter on rear polycarbonate cover 112a to an outer perimeter on front optical grade polycarbonate cover 102a to form a singular (seamless, unibody, or the like) polycarbonate housing. For additional details, see FIG. 3 illustrating a side cross-sectional view to further illustrate the monitor layer structure and physical connection points or area 115a where the covers attachment occurs and the welding occurs.

In some embodiments, a double-sided tape may be used to affix polycarbonate covers to each other. For example, in some embodiments, the assembly of monitor 100 may be used for small displays (e.g., approximately 3 inches×3 inches or smaller) more suitable as a display on a wired or wireless remote control or handset used in the commercial vehicles. In such small monitor embodiments, laser welding may be preferred over a double-side tape due to difficulty in cutting and placement of tapes in smaller dimensions. In display screen embodiments, e.g., greater than approximately 3 inches×3 inches, up to the traditional display sizes (e.g., 10-12 inch diagonal screen size or larger), double-sided tape may be preferred over laser welding due to lower costs and ease of handling or larger screen sizes.

While not explicitly shown in FIG. 1 or 2, in some embodiments, a bezel or border shading may be used around periphery of the front cover 102a to cover any visual marks of welding or double-sided taping used to form the display 100. For example, the bezel may be made up of a thin black ink (e.g., 1 mm or thinner) order along the periphery of the display. In one advantageous aspect, the bezel visually masks the welding joints, providing an aesthetically pleasing look and feel to the display. In another advantageous aspect, the black bordering provides space for a human operator, e.g., a repairman or an assembly worker to handle the display without causing the active display area to be smudged with touch marks.

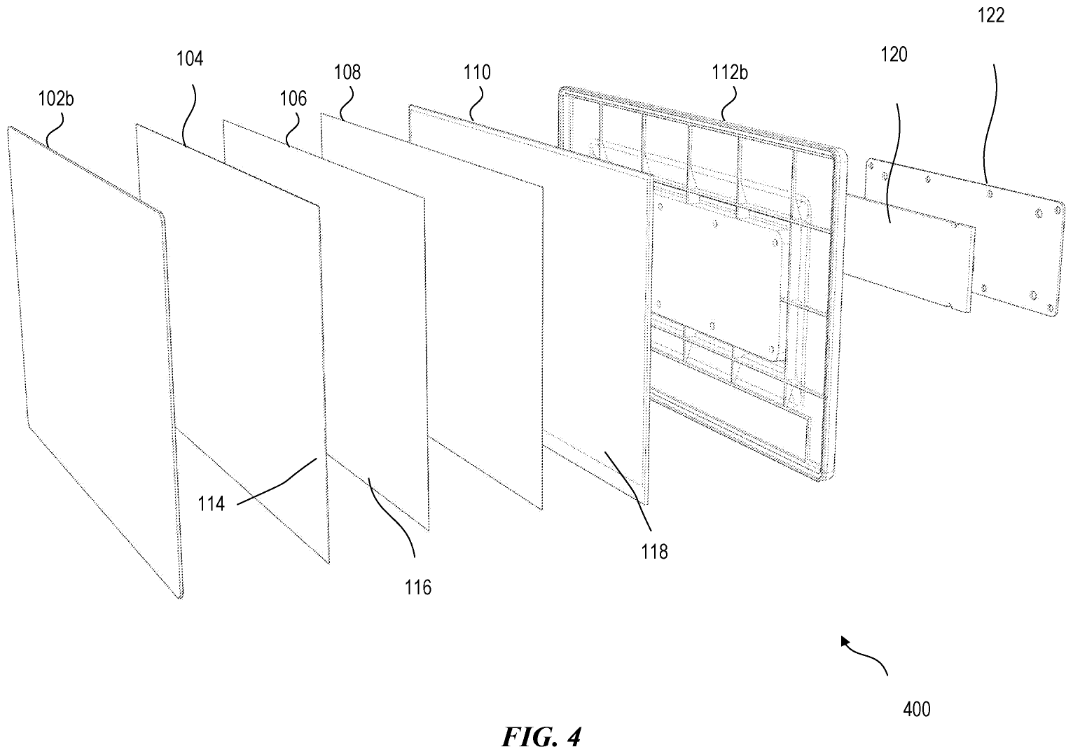

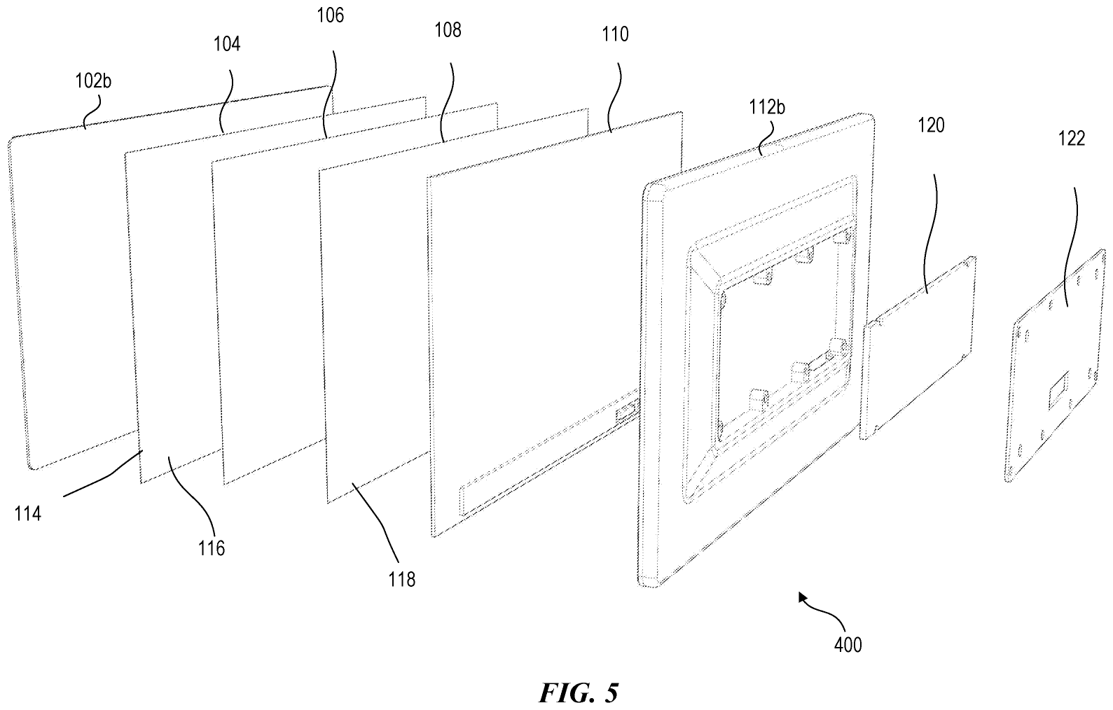

FIGS. 4 and 5 illustrate respectively an exploded front left perspective view and a rear left perspective view of the components of a second exemplary unibody polycarbonate monitor for a vehicle entertainment system installed in a commercial passenger vehicle.

Referring to FIG. 4, the exploded front left perspective view of the monitor 400, from left to right, includes a front optical grade polycarbonate cover 102b, touch panel 104, anti-reflective plastic film 106, anti-reflective film 108, display panel 110, rear polycarbonate cover 112b, printed circuit board (PCB) 120, and printed circuit board (PCB) cover 122. Referring to FIG. 5, the exploded rear perspective view of the monitor 400 from right to left, includes a front optical grade polycarbonate cover 102b, touch panel 104, anti-reflective plastic film 106, anti-reflective film 108, display panel 110, rear polycarbonate cover 112b, printed circuit board (PCB) 120, and printed circuit board (PCB) cover 122.

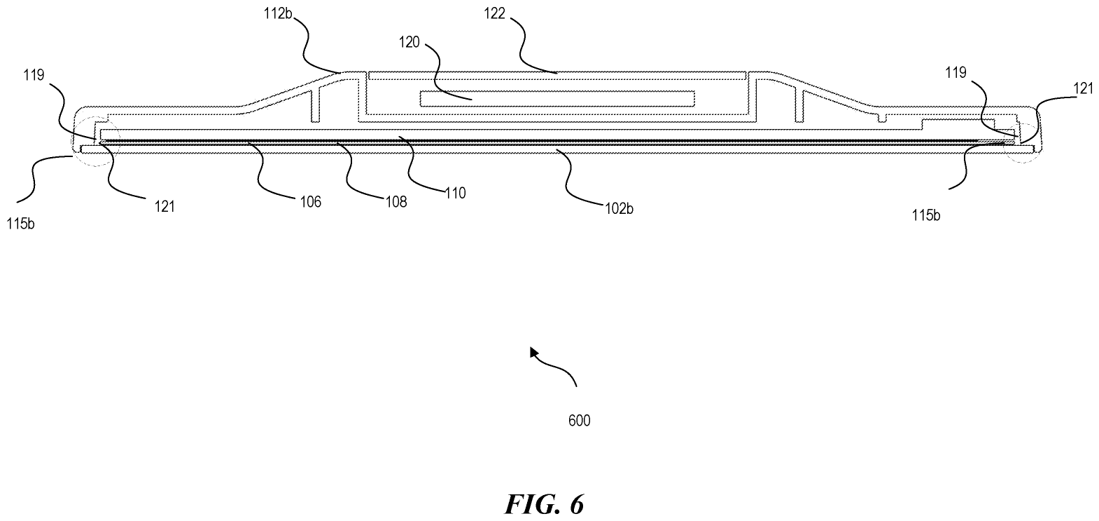

In one exemplary embodiment, front optical grade and rear polycarbonate covers 102a, 112a or 102b, 112b are by one or more welding process(s) joined together where they make contact around an outer perimeter of monitor 400. More specifically as referenced in FIGS. 1 and 2 and/or FIGS. 3 and 4, the welding process in areas 115a, 115b (see FIGS. 3 and 6) fuses along an outer perimeter on the rear polycarbonate cover 112a, 112b to an outer perimeter on the front optical grade polycarbonate cover 102a, 102b to form a singular (seamless, unibody, or the like) polycarbonate housing. As discussed above, the double-sided tape affixing process may also be used instead of the welding process.

Referring to area 115a in FIG. 3, an outer perimeter on the front optical grade polycarbonate cover 102a that is at least partly/full surrounded by an upper cupped rim/grooved channel 117 that mates to/couples to/abuts to an outer protrusion edge 119 along an outer perimeter that is at least partly/fully surrounding rear polycarbonate cover 112a.

Referring to area 115b in FIG. 6, an outer perimeter on the front optical grade polycarbonate cover 102b that is at least partly/full surrounded by an edge 121 that mates to/couples to/abuts to an outer protrusion edge 119 along an outer perimeter that is at least partly/fully surrounding rear polycarbonate cover 112b.

For additional details, see FIGS. 3 and 6 illustrating a cross-sectional view to further illustrate the monitor layer structure and physical connection points or areas.

In one example, the welding process comprises laser, chemical, or the like type of welding. Advantageously, the singular polycarbonate housing can withstand extreme physical impacts without shattering or releasing any glass shards from inside of the monitor 100, e.g., due to glass shards released/ejected from a cracked/shattered touch panel 104 or display panel 110. In one example, touch panel 104 is optically bonded to a back surface 114 of front optical grade polycarbonate cover 102a, b. In one instance, anti-reflective plastic film 106 is a layer of Mosmite laminated on the back surface 116 of touch panel 104. In one instance, the anti-reflective plastic film 108 comprises a layer of Mosmite laminated on the front surface 118 of display panel 110. In some embodiments, the affixation may be achieved using a double-sided sticky tape. Several anti-reflective plastic films 106, 108 exhibit a directional optical characteristic. For example, one surface may be covered with an anti-reflective coating awhile the opposite surface may be uncovered with anti-reflective coating. In assembly of the monitor 100, the films 106 and 108 may be aligned such that the hard coating of both films 106, 108 will be physically touching each other on the inside contact surface resulting from the affixation. This arrangement advantageously removes the display reflection ghosting as described in the present document.

Advantageously, the combination of dual/multiple layers of Mosmite effectively removes glare and improves display panel 110 image quality (for example, for software applications including gaming, Internet searching, movie watching, and the like). Furthermore, dual/multiple layers of Mosmite provides a firm, physical barrier, and support for front optical grade polycarbonate cover 102a, 102b and touch panel 104 for when a passenger presses one or more images on a screen of display panel 110. Advantageously, when a passenger presses on the front optical grade composite cover 102a, 102b to choose one or more images of command buttons or interactive display areas (e.g., on/off button(s), change channel button(s), mapping button(s), Internet access button(s), Internet URL(s), or the like) on display panel 110 using touch screen 104 on any or all monitor(s) 100, 200, 400, 500, the passenger experiences little if any detectable sagging or deflection of front optical grade polycarbonate cover 102a, 102b.

Furthermore, because display panel 110 is not permanently bonded to touch panel 104 and/or front optical grade polycarbonate cover 102a, 102b or rear polycarbonate cover 112a, 112b, it can be separated if needed, e.g., for reworking, retrofitting, upgrading, repairing, or replacing a display panel 110 or touch panel 104. For example, unlike some existing designs, where the display panel and touch panels are bonded together and therefore not independently separable for repair or replacement, the presently disclosed technique allow for separate replacement or repair of the display panel and the touch panel. In practice, touch panels are much more susceptible to wear and tear due to frequent physical contact with external objects. However, using the disclosed designs, a work our or broken touch panel could be replaced or repaired by simply separating out from the display panel at the joint (and vice versa), which could streamline and economize the repair operation. The lased welded joint or the double-side taped joint could be readily separated from each other via heat treatment using a laser source or by applying a solvent to loosen the tape.

Advantages of this monitor design include any or all the following: firstly, this unibody polycarbonate monitor design can improve the likelihood of passing Head Impact Component (HIC) tests and reduce weight/cost of the IFE system; secondly, because laser welding does not require a very wide area to achieve high strength, the border geometry dimensions of the monitor 100, 400 can be greatly reduced all the way around for a more compact monitor; and thirdly, as compared to metal monitor designs which is normally meant to help with HIC performance, a unibody polycarbonate design can be much lighter and cheaper to manufacture while achieving comparable HIC performance as a monitor design including metal.

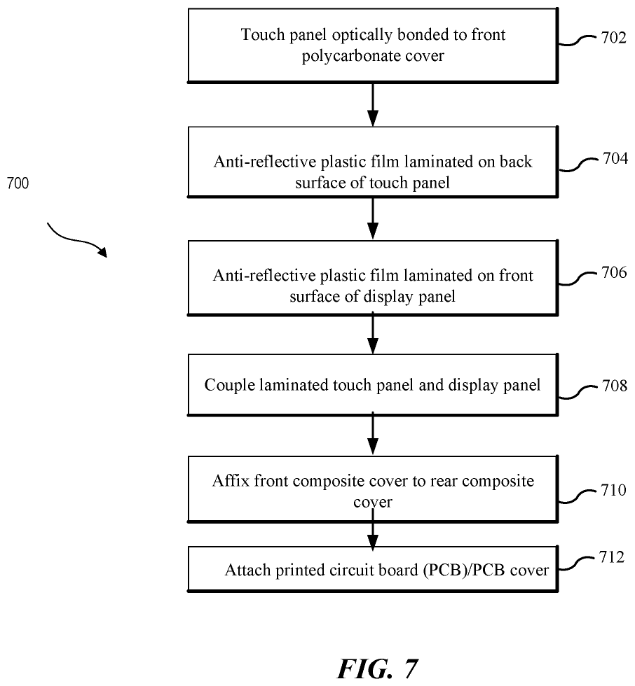

FIG. 7 shows an exemplary flowchart of a method 300 of assembling/manufacturing the exemplary monitor(s) 100, 400 for the vehicle entertainment system in a commercial passenger vehicle. In step 702, the touch panel 104 on front surface is optically bonded to the back surface of the front optical grade polycarbonate cover 102a, 102b. In step 704, anti-reflective plastic film 106 is laminated on the back surface of touch panel 104. In step 706, anti-reflective plastic film 108 is laminated on the front surface of display panel 110. The directionality of the anti-reflective plastic films 106, 108 may be as described earlier, where hard coated surface areas may be on the inside and touching each other after the bonding. In step 708, laminated anti-reflective film touch panel 104/front optical grade polycarbonate cover 102a, 102b is coupled to laminated antireflective film display panel 110/front optical grade polycarbonate cover 102a, 102b. For examples, the fasteners may be screws, metal or plastic clips, or the like. In step 710, affixation processing (e.g., welding or two-sided taping, as previously described and illustrated in connection with FIGS. 1-2) is used with laminated anti-reflective film touch panel 104/front optical grade polycarbonate cover 102a, 102b to couple it to laminated antireflective film display panel 110/rear polycarbonate cover 112a, 112b to form a singular polycarbonate monitor 100, 400. In some embodiments, prior to its use, a black ink bezel or border may be printed around the perimeter of the front cover 102a, 102b, as described in the present document. Alternatively, or in addition, the black border may be applied to the front surface after the affixation step in order to make any visual imperfections of the affixation stitch invisible to viewers. In step 712, printed circuit board (PCB) 120 is attached using one or more fasteners through printed circuit board (PCB) cover 122.

It will be appreciated that the present document discloses a display monitor that includes a front optical grade polycarbonate cover, a touch panel, a dual-layer of anti-reflection plastic film that separates the touch panel and the display panel and a rear polycarbonate cover that forms a rear cover of the display panel. The front optical grade polycarbonate cover forms a front cover of the touch panel. The front optical grade polycarbonate cover surrounds an outer perimeter of the touch panel and a display panel. The anti-reflection plastic film may be a moth-eyed plastic film. In some embodiments, the rear polycarbonate cover has a perimeter that surrounds the outer perimeter of the touch panel and the display panel. In some embodiments, the rear polycarbonate cover connectively couples to the front optical grade polycarbonate cover. In some embodiments, the welding joint is a laser induced welding joint. For example, the joint may be produced via a laser welding process. In some embodiments, the welding joint comprises a seamless fusing between the outer perimeters of the front optical grade cover and the rear polycarbonate cover, thereby resulting in a singular polycarbonate monitor housing. As further disclosed with reference to FIGS. 1 and 2, in some embodiments, the touch panel is optically bonded to a rear surface of the front optical grade polycarbonate cover. In some embodiments, the dual-layer of anti-reflection plastic film includes a layer of moth-eye anti-reflection plastic film comprising Mosmite that is laminated on a rear surface of the touch panel. In some embodiments, the dual-layer of anti-reflection plastic film including a layer of moth-eye anti-reflection plastic film comprises Mosmite that is laminated on a front surface of the display panel.

It will be appreciated that the above described embodiments of a display monitor may be produced using a manufacturing or assembling method as follows. The method may include optically bonding a touch panel on a front surface to an inside surface of a front optical grade plastic cover, laminating a first anti-reflective plastic film on a back surface of the touch panel, and laminating a second anti-reflective plastic film on a front surface of a display panel. As described in the present document, e.g., with reference to FIGS. 1 and 2, the anti-reflective films may be positioned such that the anti-reflective coatings of these films are securely in contact with each other, thereby forming an optically invisible surface. The method may further include coupling the laminated anti-reflective plastic film of the display panel to the laminated anti-reflective plastic film of the touch panel. In some embodiments, this may be performed by seamlessly forming a singular optical grade plastic monitor by attaching a rear plastic cover to the front optical grade plastic cover. In some embodiments the operation of the attaching a rear polycarbonate cover to the front optical grade plastic cover includes at least one of laser welding, chemical welding, double-sided taping, or optical bonding a rear polycarbonate cover to the front optical grade plastic cover along an outer perimeter of the covers. In some embodiments, the method may include operation of attaching a rear polycarbonate cover to the front optical grade plastic cover includes welding along the outer perimeter that abuts an outer protrusion edge respectively of the rear plastic cover to the front optical grade plastic cover. In some embodiments of this method, the laminating an anti-reflective plastic film on a back surface of the touch panel includes laminating a layer of Mosmite on the back surface of the touch panel. In some embodiments of this method, the laminating an anti-reflective plastic film on front surface of a display monitor includes laminating a layer of Mosmite on the front surface of the display panel.

It will further be appreciated that various embodiments of a unibody optical grade plastic electronic display monitor are described. The monitor may be especially suitable for commercial passenger vehicle due to superior optical properties and ease of assembling, repairing and removing the monitor from a seatback. In some embodiments, the monitor includes a touch panel, a front optical grade plastic cover; the front optical grade plastic cover forms a front side cover of the touch panel and abuts along an outer perimeter the touch panel and the display panel, a dual-layer of moth-eye anti-reflection plastic film that separates the touch panel and the display panel, and a rear plastic cover forms a backside cover of the display panel, the rear plastic cover has an outer protrusion edge that surrounds the outer perimeter of the touch panel and the display panel. For example, FIGS. 1 to 6 show various examples of such a monitor. In some embodiments, the outer protrusion edge of the rear plastic cover connectively couples to the outer perimeter of the front optical grade plastic cover. In some embodiments, the front optical grade plastic cover and the rear plastic covers are connectively coupled using a welding process along the outer protrusion edge of the rear plastic cover and the outer perimeter of the front optical grade plastic cover. In various embodiments, one or more of the following features may be incorporated in the monitor: (1) the touch panel is optically bonded to an inner surface of the front optical grade plastic cover; (2) the dual-layer of moth-eye anti-reflection plastic film includes a layer of moth-eye anti-reflection plastic film is Mosmite that is laminated on a rear surface of the touch panel; (3) the dual-layer of moth-eye anti-reflection plastic film including a layer of moth-eye anti-reflection plastic film is Mosmite that is laminated on a front side of the display panel.

While this document contains many specifics, these should not be construed as limitations on the scope of an invention that is claimed or of what may be claimed, but rather as descriptions of features specific to embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this patent document.

What is claimed is:

1. A display monitor, comprising:
a front optical grade polycarbonate cover;
a touch panel;
wherein the front optical grade polycarbonate cover forms a front cover of the touch panel;
wherein the front optical grade polycarbonate cover surrounds an outer perimeter of the touch panel and a display panel;
a dual-layer of anti-reflection plastic film that separates the touch panel and the display panel; and
a rear polycarbonate cover that forms a rear cover of the display panel.

2. The monitor of claim 1, wherein the rear polycarbonate cover has a perimeter that surrounds the outer perimeter of the touch panel and the display panel.

3. The monitor of claim 2, wherein the rear polycarbonate cover connectively couples to the front optical grade polycarbonate cover.

4. The monitor of claim 3, wherein the front optical grade polycarbonate cover and the rear polycarbonate cover are connectively coupled using a welding joint along the outer perimeters of the front optical grade polycarbonate cover and the rear polycarbonate cover.

5. The monitor of claim 4, wherein the welding joint is a laser induced welding joint.

6. The monitor of claim 4, wherein the welding joint comprises a seamless fusing between the outer perimeters of the front optical grade cover and the rear polycarbonate cover, thereby resulting in a singular polycarbonate monitor housing.

7. The monitor of claim 1, wherein the touch panel is optically bonded to a rear surface of the front optical grade polycarbonate cover.

8. The monitor of claim 1, wherein the dual-layer of anti-reflection plastic film includes a layer of moth-eye anti-reflection plastic film comprising Mosmite that is laminated on a rear surface of the touch panel.

9. The monitor of claim 1, wherein the dual-layer of anti-reflection plastic film including a layer of moth-eye anti-reflection plastic film comprises Mosmite that is laminated on a front surface of the display panel.

10. A method for manufacturing/assembling a unibody optical grade plastic monitor, the method comprising:
optically bonding a touch panel on a front surface to an inside surface of a front optical grade plastic cover;
laminating a first anti-reflective plastic film on a back surface of the touch panel; and
laminating a second anti-reflective plastic film on a front surface of a display panel.

11. The method of claim 10, further comprising:
coupling the laminated anti-reflective plastic film of the display panel to the laminated anti-reflective plastic film of the touch panel.

12. The method of claim 11, further comprising:
seamlessly forming a singular optical grade plastic monitor by attaching a rear plastic cover to the front optical grade plastic cover.

13. The method of claim 12, wherein the attaching a rear polycarbonate cover to the front optical grade plastic cover includes at least one of laser welding, chemical welding, double-sided taping, or optical bonding a rear polycarbonate cover to the front optical grade plastic cover along an outer perimeter of the covers.

14. The method of claim 12, wherein the attaching a rear polycarbonate cover to the front optical grade plastic cover includes welding along the outer perimeter that abuts an outer protrusion edge respectively of the rear plastic cover to the front optical grade plastic cover.

15. The method of claim 10, wherein the laminating an anti-reflective plastic film on a back surface of the touch panel includes laminating a layer of Mosmite on the back surface of the touch panel.

16. The method of claim 10, wherein the laminating an anti-reflective plastic film on front surface of a display monitor includes laminating a layer of Mosmite on the front surface of the display panel.

17. A unibody optical grade plastic electronic display monitor for a commercial passenger vehicle, the monitor comprising:
a touch panel;
a front optical grade plastic cover; the front optical grade plastic cover forms a front side cover of the touch panel and abuts along an outer perimeter the touch panel and the display panel;
a dual-layer of moth-eye anti-reflection plastic film that separates the touch panel and the display panel; and
a rear plastic cover forms a backside cover of the display panel, the rear plastic cover has an outer protrusion edge that surrounds the outer perimeter of the touch panel and the display panel.

18. The monitor of claim 17, wherein the outer protrusion edge of the rear plastic cover connectively couples to the outer perimeter of the front optical grade plastic cover.

19. The monitor of claim 18, wherein the front optical grade plastic cover and the rear plastic covers are connectively coupled using a welding process along the outer protrusion edge of the rear plastic cover and the outer perimeter of the front optical grade plastic cover.

20. The monitor of claim 18, wherein the touch panel is optically bonded to an inner surface of the front optical grade plastic cover; wherein the dual-layer of moth-eye anti-reflection plastic film includes a layer of moth-eye anti-reflection plastic film is Mosmite that is laminated on a rear surface of the touch panel; and wherein the dual-layer of moth-eye anti-reflection plastic film including a layer of moth-eye anti-reflection plastic film is Mosmite that is laminated on a front side of the display panel.
